(19) United States
(12) Patent Application Publication
(10) Pub. No.: US 2024/0319437 A1
(43) Pub. Date: Sep. 26, 2024

(54) PHOTONIC INTEGRATED CIRCUIT DEFINING TRENCHES THEREIN

(71) Applicant: Intel Corporation, Santa Clara, CA (US)

(72) Inventors: Xiaoqian Li, Chandler, AZ (US); Omkar G. Karhade, Chandler, AZ (US); Nitin A. Deshpande, Chandler, AZ (US); Julia Chiu, Portland, OR (US); Chia-Pin Chiu, Tempe, AZ (US); Kaveh Hosseini, Livermore, CA (US); Madhubanti Chatterjee, Portland, OR (US)

(73) Assignee: Intel Corporation, Santa Clara, CA (US)

(21) Appl. No.: 18/189,844

(22) Filed: Mar. 24, 2023

(51) Int. Cl. G02B 6/12; G02B 6/136

(52) U.S. Cl. CPC G02B 6/12002; G02B 6/136

(57) ABSTRACT

A photonic integrated circuit (PIC), a semiconductor assembly including the PIC, a multi-chip package including the PIC, and a method of forming the PIC. The PIC includes a PIC substrate, and a semiconductor layer on a top surface of the PIC substrate and including a semiconductor material and an optical component. The PIC substrate defines an air cavity therein extending in a direction from a bottom surface of the PIC substrate toward and in registration with the optical component. The semiconductor layer is free of any opening therethrough in communication with the air cavity.

### STATEMENT OF GOVERNMENT INTEREST

Embodiments were made with Government support under Agreement No. HR00111830002-0126 awarded by the United States Department of Defense. The Government has certain rights in embodiments.

### TECHNICAL FIELD

This disclosure relates generally to microelectronic devices that use light to transmit or process information.

### BACKGROUND

Silicon photonics combines integrated circuits and semiconductor photonic devices or photonics integrated circuits (PICs). A PIC includes a semiconductor device that integrates multiple photonic components on a single chip, similar to how electronic circuits integrate multiple electronic components on a single chip. These photonic components can include micro-ring resonators (MRR), waveguides, lasers, and detectors, among others. PICs can be used for a wide range of applications such as optical communications, sensing, and biomedical imaging.

A MRR is a type of optical resonator that is used in photonics and integrated optics. It includes a tiny ring-shaped structure (ring structure), typically a few micrometers in diameter, made from a high refractive index material such as silicon. When light is coupled into the ring, it circulates around the ring multiple times and interacts with the material, causing the light to resonate at specific wavelengths. These resonant wavelengths can be used for a variety of applications such as filtering, switching, and sensing.

An MRR may sometimes include an integrated heating element, such as a resistive or other heating element, in order to trim (post fabrication and typically at wafer-level) or tune (typically after singulation from a wafer and during a lifetime of the MRR) the wavelength resonance and refractive index of one or more portions thereof, such as one or more portions of its ring structure. Thermal management strategies are often employed on MRRs in order to avoid heat dissipation therefrom.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 is a cross sectional view of a portion of a photonic integrated circuit (PIC) according to the state of the art.

FIGS. 2A is a cross sectional view of a semiconductor assembly according to an embodiment.

FIG. 2B is a cross-section view through the photonic integrated circuit (PIC) shown in FIG. 2A along lines B-B.

FIG. 2C is a cross sectional view in schematic and exaggerated form of a trench of FIG. 2A.

FIG. 3A-3C are cross-sectional views of respective wafer-level temporary semiconductor assemblies in stages of fabrication to fabricate a semiconductor assembly such as the one shown in FIG. 2A.

FIG. 4A is a cross sectional view of two semiconductor assemblies formed from a singulation of the temporary semiconductor assembly of FIG. 3C.

FIG. 4B is an exploded view of a top portion of a trench within a PIC of FIG. 4A.

FIG. 5 is a flow chart of a process according to some embodiments.

FIG. 6 is a top view of a wafer and dies that may be included in a semiconductor assembly, in accordance with any of the embodiments disclosed herein.

FIG. 7 is a simplified cross-sectional side view showing an implementation of an integrated circuit on a die that may be included in various embodiments, in accordance with any of the embodiments disclosed herein.

FIG. 8 is a cross-sectional side view of a semiconductor assembly that may include any of the embodiments disclosed herein.

FIG. 9 is a block diagram of an example electrical device that may include any of the embodiments disclosed herein.

### DETAILED DESCRIPTION

Some embodiments provide a photonic integrated circuit (PIC), a semiconductor assembly including the PIC, a multi-chip package including the PIC, and a method of forming the PIC. The PIC includes a PIC substrate, and a semiconductor layer on a top surface of the PIC substrate and including a semiconductor material and an optical component. The PIC substrate defines an air cavity therein extending in a direction from a bottom surface of the PIC substrate toward and in registration with the optical component. The semiconductor layer is free of any opening therethrough in communication with the air cavity.

Advantageously, some embodiments provide a process to create a thermal management cavity for an optical component in a PIC in a manner that is easier to control than through wet etch processes of the prior art, in part because . A process according to some embodiments therefore may result in an enhanced ability to control a configuration of the thermal management cavity provided, and hence to control a thermal management effect of such cavity with respect to the optical component. In addition, advantageously, because of the absence of openings in the OCS of the PIC, some embodiments avoid plating metal and/or molding material, such as epoxy, seeping into any openings in the OCS of the PIC for the coupling of an IC component thereto.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims. In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

The technologies described herein may be implemented in one or more electronic devices. Non-limiting examples of electronic devices that may utilize the technologies described herein include any kind of mobile device and/or stationary device, such as microelectromechanical systems (MEMS) based electrical systems, gyroscopes, advanced driving assistance systems (ADAS), 5G communication systems, cameras, cell phones, computer terminals, desktop computers, electronic readers, facsimile machines, kiosks, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. Such devices may be portable or stationary. In some embodiments, the technologies described herein may be employed in a desktop computer, laptop computer, smart phone, tablet computer, netbook computer, notebook computer, personal digital assistant, server, combinations thereof, and the like. More generally, the technologies described herein may be employed in any of a variety of electronic devices, including semiconductor packages with passive heat spreaders, interface layers, TIMs, top dies, side dies, substrates, and package substrates.

As used herein the terms “top,” “bottom,” “upper,” “lower,” “lowermost,” and “uppermost” when used in relationship to one or more elements are intended to convey a relative rather than absolute physical configuration. Thus, an element described as an “uppermost element” or a “top element” in a device may instead form the “lowermost element” or “bottom element” in the device when the device is inverted. Similarly, an element described as the “lowermost element” or “bottom element” in the device may instead form the “uppermost element” or “top element” in the device when the device is inverted.

As used herein, reference to a “die” is meant to broadly refer to a die, a chiplet, a chip complex, a chiplet complex, or any other integrated circuit structure including circuitry therein supported on a substrate. While the terms die, chip, and chiplet may be used interchangeably, the term chiplet is sometimes used to refer to an integrated circuit die that implements a subset of the functionality of a larger integrated circuit component, the larger integrated circuit component formed using one or more chiplets connected by inter-die interconnects (e.g., interposers, bridges, local interconnect components, local silicon interconnects). The use of chiplets in integrated circuit components has become attractive as feature sizes have reduced and the demand for high-performance larger integrated circuit components has increased. The approach of assembling multiple known-good dies (chiplets) to form a larger integrated circuit component results in improved manufacturing efficiencies as the overall yield of an integrated circuit component assembled from multiple small chiplets is better than that of an integrated circuit component in which the functionality of the chiplets is implemented on a single large integrated circuit die. Any integrated circuit die, chip, or chiplet can implement any portion of the functionality of any processor unit described or referenced herein.

As used herein, the term “the material” of component A may refer to one or more constituent materials of component A. For example, where component A includes 3 sublayers made of three respective materials X, Y and Z, the disclosure herein may refer to “the material of component A” to refer to one or more of materials X, Y and Z that make up component A.

As used herein, the term “electronic component” can refer to an active electronic circuit/active electronic component (e.g., processing unit, die, chiplet, memory, High Bandwidth Memory (HBM), storage device, FET, etc.) or a passive electronic circuit/passive electronic component (e.g., resistor, inductor, capacitor, etc.).

As used herein, the term “electronic integrated circuit component” (or EIC, or IC component) can refer to an electronic component that may be integrated in a semiconductor assembly and configured to perform a function using electricity to communicate signals. An integrated circuit (IC) component can comprise one or more of any electronic components, such as any electronic components described or referenced herein, or any other computing system component, such as a processor unit (e.g., system-on-a-chip (SoC), processor core, graphics processor unit (GPU), accelerator, chipset processor), I/O controller, memory, or network interface controller, and can comprise one or more additional active or passive devices such as capacitors, decoupling capacitors, resistors, inductors, fuses, diodes, transformers, sensors, electrostatic discharge (ESD) devices, and memory devices.

A non-limiting example of an unpackaged IC component includes a single monolithic IC die (shortened herein to “die”); the die may include solder bumps attached to contacts on the die. When present on the die, the solder bumps can enable the die to be directly attached to a printed circuit board (PCB).

As used herein, the term “optical component” can refer to an optical device that may be integrated in a semiconductor assembly, and configured to perform a function using light to communicate signals. An optical component may for example comprise one or more of: a MRR, an optical modulator (e.g., used to modulate the amplitude or phase of light in optical-based optical circuits, such as a MRR or a Mach-Zehnder interferometer (MZI)), an optical photodetector (e.g., used to convert optical signals into electrical signals in optical-based optical circuits), an optical filter (e.g., used to selectively filter out certain wavelengths of light in optical-based optical circuits), an optical coupler (e.g., used to couple light into and out of optical waveguides in optical-based optical circuits), an optical mirror (e.g., used to reflect light in optical-based optical circuits), an optical splitter (e.g., used to split an incoming optical signal into multiple output signals in optical-based optical circuits), an optical switch (e.g., used to route optical signals between different waveguides or channels in optical-based optical circuits), an optical amplifier (e.g., used to amplify optical signals in optical-based optical circuits), or an optical laser (e.g., used to generate coherent light in optical-based optical circuits.

In various embodiments, an optical component, such as a MRR, may be located on a silicon-on-insulator (SOI) wafer, where the substrate may include silicon.

As referred to herein, a “PIC” refers to a device that integrates one or more photonic components onto a single chip or substrate, similar to how integrated circuits integrate one or more electronic components onto a single chip. PICs are used in optical communication, sensing, and computing applications and are designed to enable the miniaturization and integration of complex optical systems. A photonic integrated circuit typically includes a series of photonic components, such as lasers, modulators, detectors, filters, and waveguides, that are integrated on a common substrate, such as silicon or indium phosphide. The optical components are connected to each other through waveguides, which guide and direct the flow of light signals. The optical components are typically fabricated using lithographic techniques that allow for the precise control of their dimensions and placement.

PICs can offer several advantages over traditional optical systems, including reduced size, weight, and power consumption. They can also offer improved performance and reliability, as the integration of multiple components reduces the number of optical connections and potential sources of signal loss or interference.

PICs can be used in a variety of applications, including telecommunications, data centers, medical imaging, and environmental sensing. They are also being explored for use in emerging fields such as quantum computing and sensing, where their ability to integrate multiple optical functions on a single chip offers significant advantages.

As used herein, a “semiconductor component” refers to a semiconductor device, such as an electronic or photonic or MEMs component made from semiconductor material that exhibits a specific behavior and/or performs one or more specific functions. The operation of a semiconductor device relies in part on the properties of semiconductor materials, which have conductivity (e.g., with electricity and/or light) between that of conductors and insulators. The electrical conductivity of a semiconductor can be controlled and modified by introducing impurities, a process known as doping. Doping creates areas of excess electrons or holes within the material, allowing for the controlled flow of current through the device. The optical conductivity within an optical component may be controlled by controlling the refractive indices of waveguides therein. Examples of semiconductor components or semiconductor devices include ICs and/or PICs.

As used herein, a “heating element” integrated in an optical component may refer to any structure that has the effect of raising a temperature of at least a portion of the optical components in a controlled manner. Heating elements are used in photonic components for various purposes such as temperature control, tuning, and stabilization. Some examples of heating elements used in photonic components resistive heaters, thermos-electric heaters, optical absorption heaters, microheaters, and micro-electro-mechanical systems (MEMS) heaters. Resistive heaters are the most commonly used heating elements in photonic components. They are made of materials with high electrical resistance, such as platinum, tungsten, and nickel-chromium alloys. These materials are deposited on a substrate or embedded in the device, and when a current is passed through them, they heat up and raise the temperature of the surrounding area. Thermo-electric heaters are based on the principle of the Peltier effect, where a temperature gradient is created by passing a current through a junction of dissimilar materials. They are used for precise temperature control and stabilization, and are often used in combination with resistive heaters. Optical absorption heaters use the absorption of light to generate heat. They are often used in optical waveguides and fibers, where a localized temperature increase is required to adjust the refractive index or to create a thermal lens. Microheaters are tiny resistive heaters that are integrated into photonic devices such as lasers, modulators, and sensors. They are used for precise temperature control and tuning of these devices. MEMS heaters are miniaturized heating elements that can be integrated into photonic devices. They are often used for thermal tuning and actuation, and can be operated by applying an electrical voltage or a magnetic field. Overall, the choice of heating element depends on the specific application and the requirements for temperature control, tuning, and stability.

As used herein, a “semiconductor assembly” refers to a structure corresponding to an assembly of individual semiconductor components, such as integrated circuits (ICs) and/or PICs, onto a substrate or package. The assembly process may involve several steps, including component attach, wire bonding or flip-chip bonding, encapsulation, and testing. In the component attach process, the semiconductor component is attached to a substrate or lead frame using an adhesive or solder. In the wire bonding process, thin wires are used to connect the bond pads on the component to the corresponding pads on the substrate or lead frame. In flip-chip bonding, the component is flipped and bonded directly to the substrate or package, allowing for higher-density connections and shorter wire lengths. After the semiconductor component attach and interconnection process, the assembly may be encapsulated with a protective material, such as epoxy or plastic, to provide mechanical protection and environmental stability. Finally, the assembly may be tested to ensure that it meets the design specifications and performance requirements.

As used herein, “pitch” may be measured center-to-center between two elements (e.g., from a center of a trench to a center of an adjacent trench).

As used herein, “contacts” may refer to electrically conductive structures of or on a first microelectronic component (e.g., an electronic component, a substrate, a panel layer, etc.) that may be electrically coupled to contacts of a second microelectronic component. Contacts may include, for example, solder balls, pads, or pins.

“Electrically conductive structures” as used herein may include an electrically conductive material such as a metal (e.g., copper, aluminum, nickel, cobalt, iron, tin, gold, silver, or combinations thereof). Examples of electrically conductive structures may include traces, which extend horizontally, and vias, which extend vertically.

By “A is embedded in B,” what is meant herein is that B at least partially covers side surfaces of A, and at most covers all surfaces of A.

An existing example of a packaged semiconductor assembly comprises one or more integrated circuit dies mounted on a package substrate with the integrated circuit dies and package substrate encapsulated in a casing material, such as a metal, plastic, glass, or ceramic. Often the casing includes an integrated heat spreader (IHS); the packaged integrated circuit component often has bumps, leads, or pins attached to the package substrate (either directly or by wires attaching the bumps, leads, or pins to the package substrate) for attaching the packaged integrated circuit component to a printed circuit board (or motherboard or base board) or another component.

The following detailed description is not intended to limit the application and use of the disclosed technologies. It may be evident that the novel embodiments can be practiced without every detail described herein. For the sake of brevity, well-known structures and devices may be shown in block diagram form to facilitate a description thereof.

For convenience, a phrase referring to element “X,” where X is a reference numeral, may be used to refer to any one of elements XA-XB if elements have been disclosed as such and marked as such on the accompanying drawings.

Semiconductor assemblies, and related devices and methods, are disclosed herein.

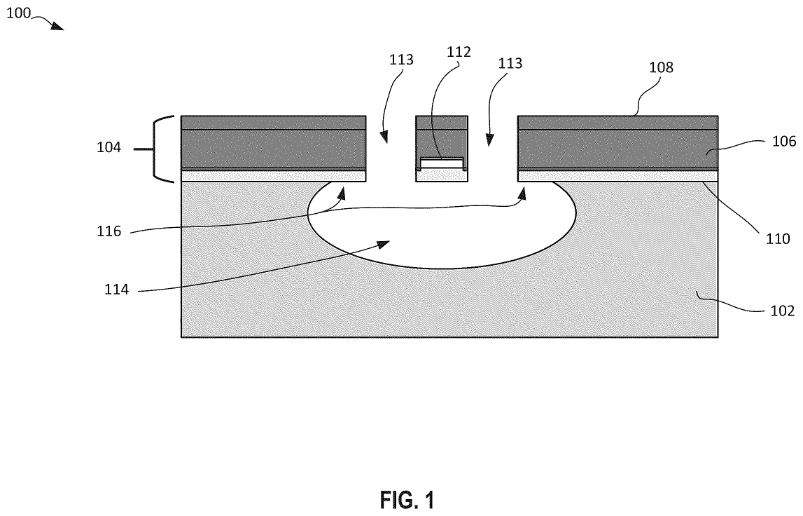

FIG. 1 shows a portion 100 of a PIC according to the state of the art. The portion 100 of the PIC includes a substrate 102, such as a silicon substrate, and a semiconductor layer in the form of optical component strata (OCS) 104. In the shown example, the OCS 104 includes an optical component layer (OCL) 106 sandwiched between two oxide layers 108 and 110. OCL 106 may include a semiconductor material, such as a semiconductor crystalline material, such as crystalline silicon. OCL 106 further includes an optical component 112. Oxide layer 108 corresponds to a cladding layer, and may include, for example silicon dioxide. Oxide layer 110 corresponds to a buried oxide (BOX) layer, and may also include silicon dioxide. The BOX layer 110 may overly the silicon substrate 102 and may separate the OCL 106 therefrom.

In order to ensure thermal management of the optical component 112, the state of the art uses an etching process to first provide openings 113 extending through the OCS 104, and to subsequently provide an air cavity 114 extending below the optical component 112. The state of the art cavity 114 defines undercut regions 116 extending under the OCS 114 on opposing sides of openings 113. The configuration of the air cavity 114 is typically brought about by virtue of the use of wet etch processes in order to etch through the OCS 104 and the silicon substrate 102. Cavity 114 ensures thermal management especially where the optical component 112 includes one or more heating elements. The temperature around optical components that generate heat, such as a MRR with an integrated heating element, ought to be well controlled. To do so, the prior art provides voids or cavities under the optical component to isolate the optical component from the bulk Si substrate supporting the optical component to avoid heat dissipation therefrom. Normally, an air trench is created on the surface of the layer that includes the optical component, and a volume of Si below that will be etched out to create an air pocket during PIC fabrication process.

However, embodiments contemplate that etch processes to provide cavities underlying optical components according to the prior art are difficult to control. As a result, the effects of such etch processes on the impacted zones can lead to unpredictable outcomes, such as cavities exhibiting substantial undercut regions and appreciable widths. In addition, such etch processes, because of the presence of openings 113 within the OCS 104, can lead to unpredictable results during the bumping process, where plating metal and/molding material, such as epoxy, could seep into such openings.

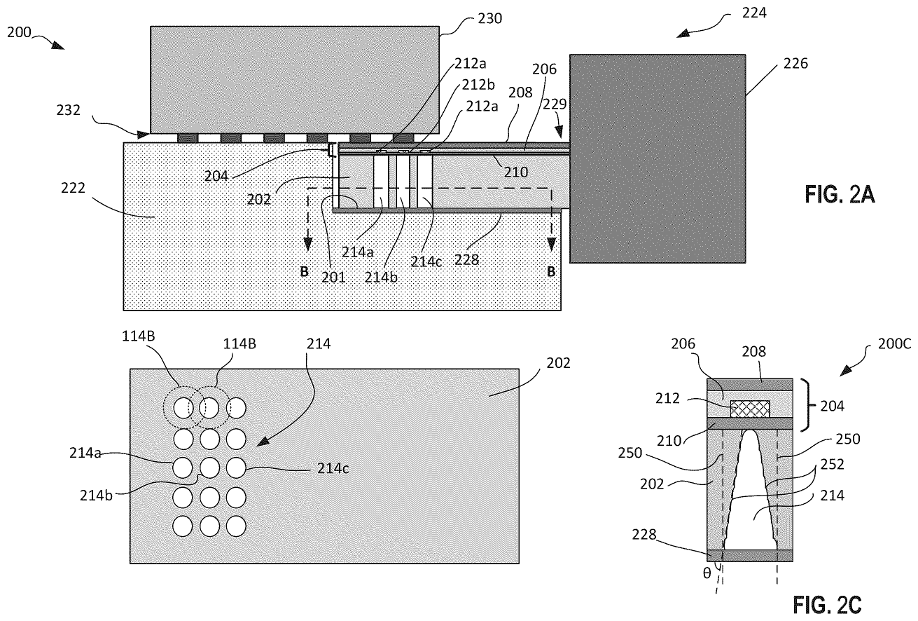

Reference is now made to FIGS. 2A and 2B, which show respectively, a semiconductor assembly 200 including a PIC 220 according to an embodiment, and a cross-sectional view across the PIC 220 of FIG. 2A along lines B-B.

Referring first to FIG. 2A, semiconductor assembly 200 includes a semiconductor structure in the form of PIC 220 according to one embodiment.

PIC 220 includes a substrate 202, such as a silicon substrate, and optical component strata (OCS) 204 at a top surface of the substrate 202. In the shown example. the OCS 204 includes an optical component layer (OCL) 206 sandwiched between two oxide layers 208 and 210. OCL 206 may include a crystalline material, such as crystalline silicon. OCL 206 further includes an array of optical components such as optical components 212a, 212b and 212c. Oxide layer 208 corresponds to a cladding layer, and may include, for example silicon dioxide. Oxide layer 210 corresponds to a buried oxide (BOX) layer 210, and may also include silicon dioxide. The BOX layer 210 may overly the silicon substrate 202 and may separate the OCL 206 therefrom.

According to some embodiments, thermal management of the optical components within the OCL 206 involves the provision of trenches 214, such as trenches 214a, 214b and 214c as visible in FIG. 2A. Trenches 214 extend in a direction from a bottom surface 201 of substrate 202 toward the OCL 206. According to some embodiments, the trenches extend from the bottom surface of substrate 202 at their first end, and end at the OCL 206 at their second end. According to some embodiments, individual ones of the trenches extend substantially perpendicularly with respect to the bottom surface of the substrate. According to some embodiments, individual ones of the trenches are in registration with respective ones of the optical components 212a, 212b and 212c. The trenches stop at the BOX layer 210, and the OCS 204 does not exhibit openings therein connecting to the trenches 214, as compared with the openings 113 of FIG. 1 that were necessary for the provision of and connected to cavity 114 for thermal management of optical component 112 in the state of the art as shown in FIG. 1.

In some embodiments, BOX layer 210 may be about 2 to 3 microns thick (measured in a direction from its top surface to its bottom surface); the substrate 202 may be in a range of about 50 to about 200 microns thick (wherein “about” means plus or minus 2%); cladding layer 208 may have a thickness of about 20 microns, and OCL 206 may have a thickness of about 200 nm. In some embodiments, in areas not including an optical component, the cladding layer 208 and the BOX layer 210 may be indistinguishable from each other.

The optical components 212 of FIG. 2 may include any optical components, and may be similar to each other, or different from each other. One or more of the optical components 212 may include one or more heating elements. The provision of a trench 214 in PIC 220 may correspond to an optical component 212 that integrates a heating element therein. In the case of the latter, the trench 214 may be even more useful in facilitating thermal management of the optical component 212. According to an embodiment, a trench 214 may be “in registration” with an optical component 212 by having its closed end portion 234 fully or partially abut a footprint of the optical component 212. According to some embodiments, a trench 214 may be in registration with one or more optical components 212.

One or more optical components 212 may, for example, include an MRR. The MRR may include a silicon waveguide structure that may comprise lightly-doped P region, lightly-doped N region, highly-doped P+ region, highly-doped N+ region, intrinsic silicon and silicon dioxide (as a divider between different Si doping regimes). A non-limiting way to identify an MRR is to visually inspect the materials present in a cross-sectional view and the structure and shape of the materials in order to determine that the silicon waveguide has been implemented. Although, in various embodiments, an MRR may comprise the same materials as a CMOS component, the structure of an MRR, and its shape employ different doping profiles than a CMOS component. Embodiments of an MRR where used as an optical component may have a thickness of about 220 nanometers.

Semiconductor assembly 200 further includes an IC component 230, such as a die, which IC component 230 is electrically coupled to a package substrate 222 by way of electrically conductive structures in the form of bumps 232. The shown embodiment of semiconductor assembly 200 depicts a flip chip attachment of IC component 230 to the PIC 220. Because some embodiments do away with the need for the provision of any openings in the OCS 204 in order to make the provision of thermal management cavities such as trenches 214 possible, a coupling of an IC component to the PIC would, advantageously, avoid the seeping in of metal plating material into the cavities during a bumping process, and avoid the seeping in of any molding material such as epoxy into the cavities, as may happen with configurations of the prior art as shown in FIG. 1.

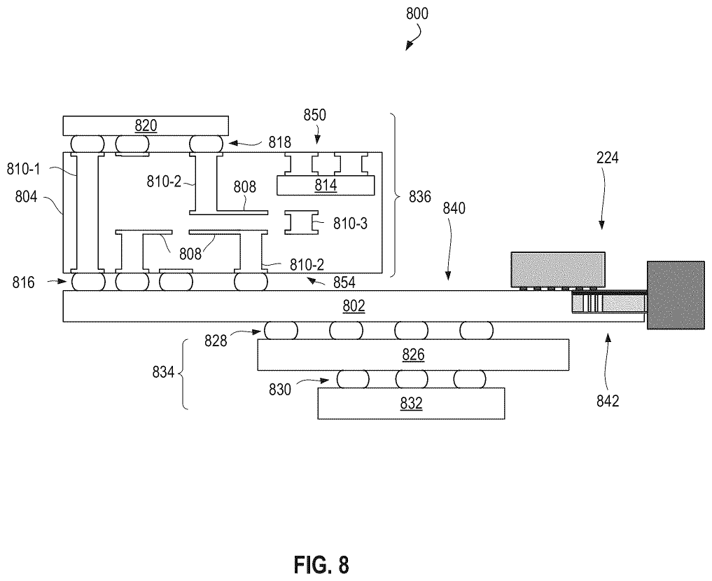

The combination of everything in semiconductor assembly 200 of FIG. 2A minus the package substrate 222 will be referred to hereinafter as an IC-PIC-FAU assembly 224, which will be mentioned further below in the context of FIG. 8.

Package substrate 222 may include, by way of example, a core layer and build-up layers on one side or on both sides of the core layer (not shown), where the core layer includes a non-conductive material, such as glass, silicon or an organic material (e.g., epoxy). The build-up layers may include successive non-conductive layers and successive metal layers (or redistribution layers (RDLs) (e.g., M1, M2, . . . Mn) between the dielectric layers.

The PIC 220 is shown as having been provided within a ledge region 221 defined by the package substrate at a side thereof, and as having been mechanically affixed to the package substrate by way of an adhesive layer 228, such as a double-sided adhesive film (DAF). IC component 230 may be electrically coupled to the PIC 220 by way of a number of the bumps 232 as shown. Electrical signals from the IC component 230 may be converted to corresponding optical signals within the PIC 220, and vice versa, through one or more electro-optic modulators of PIC 220. Electro-optic modulators are one form of optical components, and may include Mach-Zehnder interferometers (MZI), electro-absorption modulators, and phase modulators, to name a few.

Light may be coupled into and out of PIC 220 for signal communication therewith using optical pathway 229. Optical pathway 229 may take any suitable form, such as one or more optical couplers or waveguides of the PIC. The specific optical pathway used depends on the design of the PIC and the application requirements. One common method for coupling light into a PIC is through the use of a grating coupler as an embodiment of the optical pathway 229. A grating coupler is a periodic structure that is designed to efficiently couple light from an optical fiber or waveguide into or out of a PIC. The grating coupler can be fabricated directly on the surface of the PIC using lithography and etching techniques, allowing for efficient and compact coupling of light. Another method for coupling light into a PIC is through the use of an edge coupler. An edge coupler is a structure that couples light from a waveguide on the edge of the PIC into an external optical fiber, or vice versa. Edge couplers can be fabricated using a variety of techniques, including fiber alignment, lithography, and etching.

Optical pathway 229 is coupled to a fiber array unit (FAU) 226 as shown. According to an example, FAU 226 may include an array of optical fibers that are precisely aligned and terminated at both ends. The fibers are typically arranged in a linear array or a two-dimensional grid, and are used to transmit or receive light signals. FAU 226 may be used in optical switching and routing applications where multiple fibers need to be connected and routed to different locations.

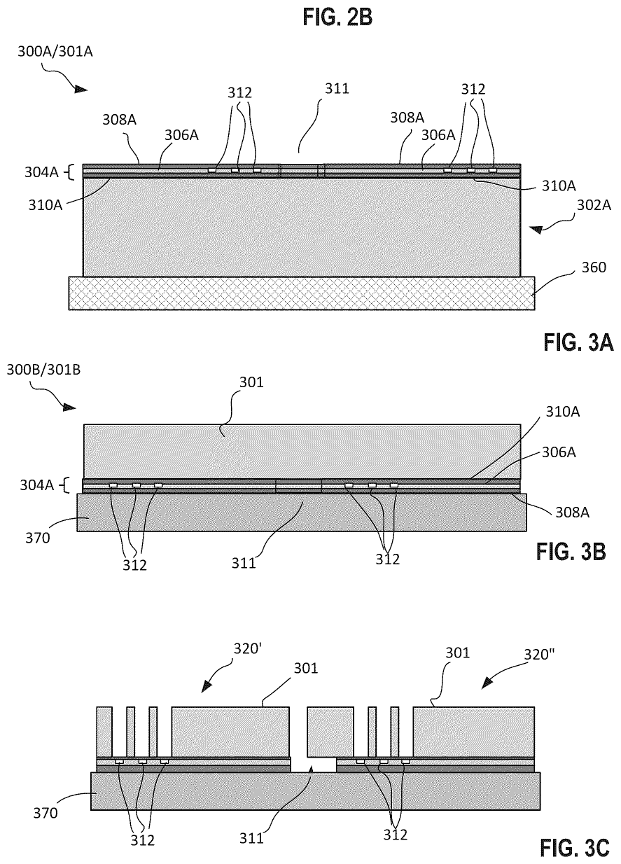

Referring back to PIC 220, trenches 214 according to some embodiments may be provided using a plasma etch process, including a dry etch process using one or more suitable gases, such as gases typically used during plasma dicing of PICs at a wafer level. According to some embodiments, the trenches present substantially straight sidewalls extending from a bottom surface of substrate 202 up to the OCS 204. As compared with cavities of the prior art, as shown for example in the context of FIG. 1, trenches of some embodiments have only negligible undercuts/are substantially free of undercuts, such as undercuts 116, appearing at regions adjacent to their corresponding optical components. An example process will be addressed in more detail in the context of FIGS. 3A-3C below.

Referring now to FIG. 2B, a cross-sectional view 200B is shown through the substrate 202 of PIC 220 of FIG. 2A. Substrate 202 defines an array 215 of trenches 214, including trenches 214a, 214b and 214c of FIG. 2A. Although the array 215 of trenches in FIG. 2B is an ordered array of trenches showing similar cross-sectional dimensions and circular cross-sectional profiles, embodiments are not so limited. Embodiments include within their scope the provision of one or more trenches in a PIC having any cross-sectional profile, such as a square, a rectangle, a triangle, an ellipse or any other shape. Embodiments further include within their scope the provision of multiple trenches not in an ordered array, and/or of multiple trenches having dimensions or profiles different from one another.

Referring still to FIG. 2B, the figure further shows, in broken lines and not necessarily to scale, the lateral extent of possible cavities 114B, similar to cavities 114 of FIG. 1, that could have resulted had air cavities been used according to a thermal management solution of the prior art. The possible cavities 114B in FIG. 2B suggest among other things one of the many technical advantages of embodiments, in that trenches according to some embodiments allow further scaling and miniaturization of PICs by allowing optical components within a given PIC, such as to be placed closer to one another than would have been possible according to the prior art in part because trenches according to some embodiments result in minimal or no undercut regions but rather in cavities defined by substantially straight side walls. The latter allows optical components to be placed closer together on a PIC while enjoying benefits of a heat management solution involving the provision of air cavities or pockets thereunder.

Reference is now made to FIG. 2C, which shows, in schematic form and not to scale, a portion 200C of a trench region of PIC 220 of FIG. 2A. Portion 200C includes a portion of substrate 202, OCS 204, OCL 206, capping layer 208, BOX layer 210, optical component 212, along with trench 214 with its opening on adhesive layer 228. The sidewall profiles of trench 214, according to the embodiment of FIG. 2C, may exhibit scalloped profiles 252, a bowl shaped or concave end region 254, and may altogether present an angle theta θ with respect to ideal vertical lines 250 shown in broken lines in FIG. 2C, for example such trench 214 has been formed using dry etching, for example deep reactive ion etching (DRIE). The angle θ, the scalloped profile and/or the presence of a bowl shaped (or concave) end region of a trench are shown schematically and in exaggerated form in FIG. 2C, and the presence of one or more of these features in a provided below an optical component is meant to suggest the use of plasma etching such according to some embodiments. The sidewalls may be rough according to some embodiments because of the scalloping effect, and the bottom of the etch pit is bowl shaped due to the cyclic nature of a dry etch process. The angle θ is usually less than/smaller than 90° and, in an example, may be approximately equal to tan−1 [2 h/(Wp−Wm)], where Wp is the pattern width, Wm is the width of the mask aperture used to create the trench, and h is the etch depth. In certain embodiments, sidewalls of a trench may be polished or otherwise processed in order to reduce the roughness thereof.

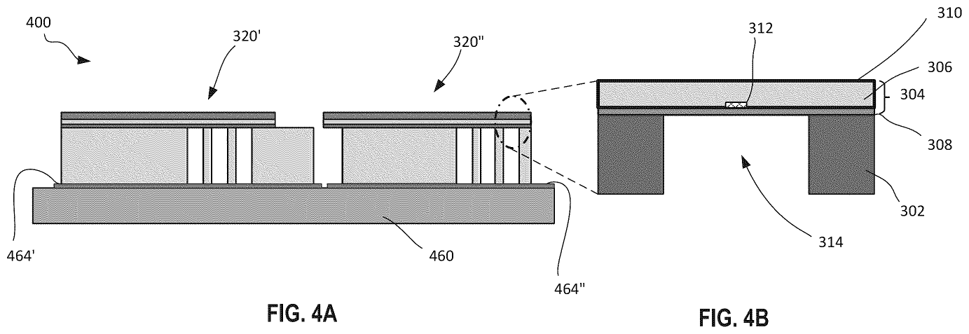

Reference is now made to FIGS. 3A-3C and 4, which show various stages for the fabrication of a PIC similar to PIC 220 of FIG. 2A.

At FIG. 3A, a temporary microelectronic structure 300A includes a wafer 301A including a PIC substrate stratum 302A and a semiconductor layer stratum 304A having a plurality of optical components 312 therein. The wafer 301A may for example include silicon. Semiconductor layer stratum 304A includes a cladding sheet 308A, a BOX sheet 310A, and an optical component stratum 306A between the cladding sheet 308A and the BOX sheet 310A. The cladding sheet 308A and the BOX sheet 310A may be similar in terms of respective materials and functions as the cladding layer 208 and BOX layer 210 of FIG. 2A. The optical component stratum 306A may include a plurality of optical components therein, similar to OCL 206 of FIG. 2A. A street 311 may be defined through the semiconductor layer stratum 304A and through part of the wafer 301A in order to mark a location for later dicing. The street may be provided to have substantially straight and substantially vertical sidewalls for ease of optical coupling of the optical components inside the optical component stratum 306A. The wafer 301A is supported on a dicing tape 360 as shown. A thickness of the wafer 301A may be about 700 microns, a thickness of the cladding sheet 308A may be about 20 microns, a thickness of the BOX sheet 310A about 2 microns, and a total thickness of the optical component stratum about 200 microns.

Referring now to FIG. 3B, the temporary semiconductor structure of FIG. 3A is shown as having been transferred onto a carrier 370 with a “free” surface of cladding sheet 308A (in relation to FIG. 3A) contacting the carrier 370, and with the wafer 301A of FIG. 3A as having been reduced in thickness to about 55 microns to yield a temporary semiconductor assembly 300B with wafer 301B.

Referring now to FIG. 3C, the temporary semiconductor structure of FIG. 3B is shown as having been singulated into individual PIC structures 320′ and 320″, with each such PIC structure corresponding to a PIC, similar for example to PIC 220 of FIG. 2A. In FIG. 3C, according to an embodiment, a plasma etching process has been used to both singulate the wafer 301B up to the street 311, and further to, for example at the same time as dicing, provide, from a the exposed bottom surface of the PICs 301, trenches 314 into each PIC structure 320′ and 320″ as shown. The trenches may be similar to trenches 214 as described in more detail in the context of FIGS. 2A-2C. Preferably, there is provided one trench per optical device in each PIC structure 320′ and 320″ in order to keep the trench features as small as possible and to provide more mechanical stability to each resulting PIC as would have been provided with the provision of larger trenches. The provision of trenches 314 may be with the help of a PIC trench mask (not shown) having openings therein corresponding to the location of trenches to be provided. For example, a PIC trench mask according to some embodiments may include an array of cavity openings therein to match an array of corresponding trenches to be dry etched into a substrate of a PIC. Some embodiments contemplate the use of standard dry etch processes involving the use of plasma in dry etch chambers, where the plasma is to react with the material (such as silicon) of the substrate of a PIC to be formed, and to react therewith to form a gas from such material which may be pumped away from the chamber.

Reference is now made to FIGS. 4A and 4B, which show, respectively, the PIC structures 320′ and 320″ of FIG. 3C as having been moved onto a dicing tape and respective DAFs (FIG. 4A) and an exploded view of a trench and optical component region of a PIC structure of FIG. 4A (FIG. 4B).

As seen in FIG. 4A, shows a temporary semiconductor assembly 400 including PIC structures or PICs 320′ and 320″ have been placed onto a dicing tape 460 and respective DAFs 464′ and 464″ prior to packaging of the PICs into a semiconductor assembly similar to the semiconductor assembly 200 of FIG. 2A. Each PIC structure 320′ and 320″ may correspond to a PIC comparable to PIC 220 of FIG. 2. The DAFs 464′ and 464″ allow each PIC 320′ and 320″ to be affixed within a semiconductor assembly, similar to DAF 228 of semiconductor assembly 200 of FIG. 2A.

As seen in FIG. 4B, an exploded view of a portion of PIC 320″ shows an upper portion of trench 314 within substrate 302, the trench 314 ending at BOX layer 308 of OCS 304. OCS 304 further includes cladding layer 310, and OCL 306, which includes an optical component 312.

Although the instant description describe the trenches according to some embodiments as extending to a BOX layer, embodiments are not so limited, and include within their scope the provision of a trench having a length extending from a bottom surface of a substrate of a PIC in a direction toward one or more optical components of the PIC, and, for example, ending at a BOX layer, ending at a OCL that includes the one or more optical components, or ending within the substrate of a PIC at a region adjacent one or more optical components of the PIC, in a manner to provide thermal management of the one or more optical components.

Some embodiments provide a PIC configuration where cavities are provided in the PIC substrate for thermal management of optical components of the PIC from a bottom surface of the PIC substrate and without providing openings in an OCS of the PIC in order to form such cavities. In some embodiments, the cavities correspond to trenches. In some embodiments the trenches are provided by way of plasma etching. In some embodiments, the trenches are provided during dicing of the PIC at the wafer level.

Advantageously, some embodiments provide a process to create a thermal management cavity for an optical component in a PIC in a manner that is easier to control than through wet etch processes of the prior art, in part because. A process according to some embodiments therefore may result in an enhanced ability to control a configuration of the thermal management cavity provided, and hence to control a thermal management effect of such cavity with respect to the optical component. In addition, advantageously, because of the absence of openings in the OCS of the PIC, some embodiments avoid plating metal and/or molding material, such as epoxy, seeping into any openings in the OCS of the PIC for the coupling of an IC component thereto. Moreover, some embodiments result in an air cavity configuration that avoid the substantial undercuts created by processes of the prior art, in this manner resulting in cavities the configurations of which are easier and more predictable to control.

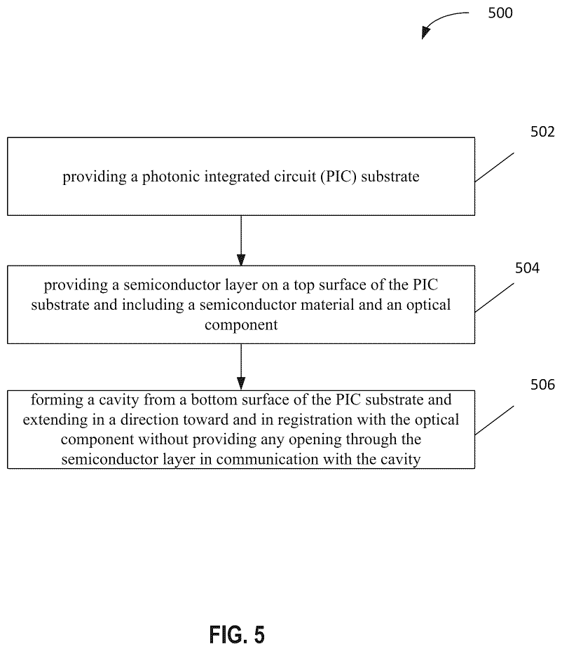

FIG. 5 is a flowchart of a process 500 according to some embodiments. At operation 502, the process includes providing a photonic integrated circuit (PIC) substrate. At operation 504, the process 500 includes providing a semiconductor layer on a top surface of the PIC substrate and including a semiconductor material and an optical component. At operation 506, the process 500 includes forming an air cavity from a bottom surface of the PIC substrate and extending in a direction toward and in registration with the optical component without providing any opening through the semiconductor layer in communication with the air cavity.

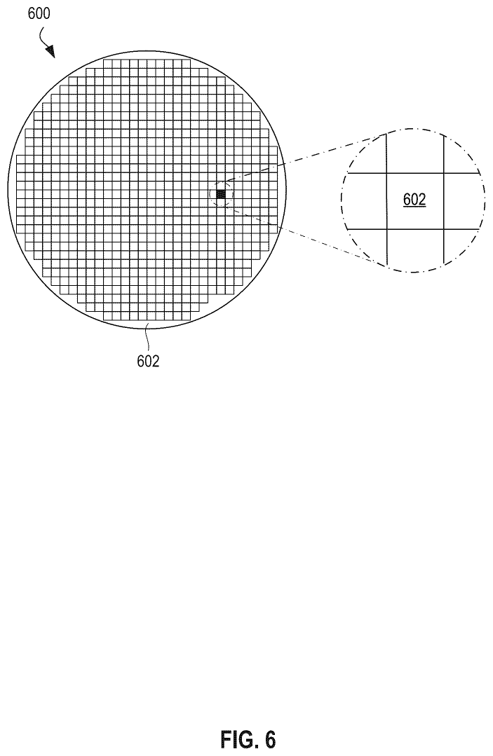

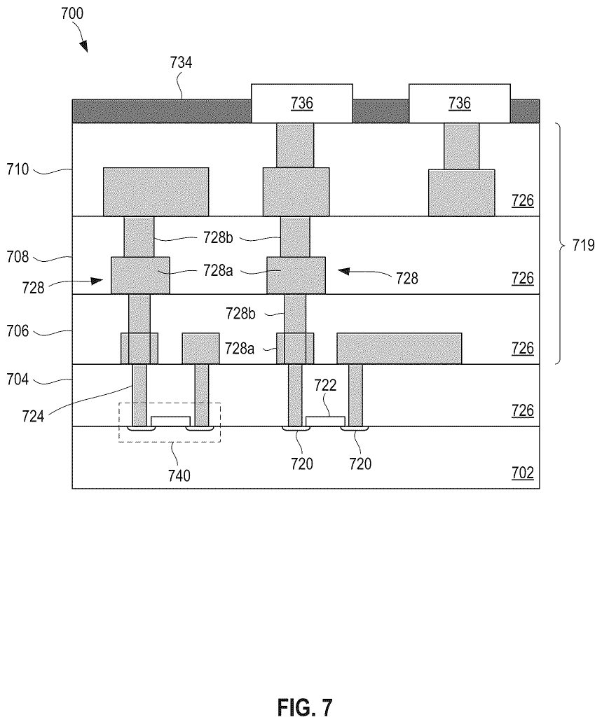

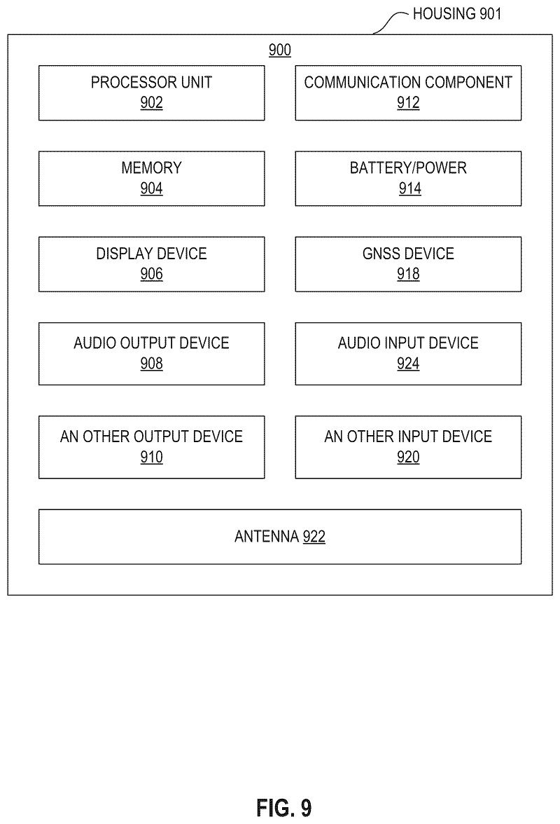

FIG. 6 is a top view of a wafer 600 and dies 602 that may be included in any of the embodiments disclosed herein. The wafer 600 may be composed of semiconductor material and may include one or more dies 602 formed on a surface of the wafer 600. After the fabrication of the integrated circuit components on the wafer 600 is complete, the wafer 600 may undergo a singulation process in which the dies 602 are separated from one another to provide discrete “chips” or destined for a packaged integrated circuit component. The individual dies 602, comprising an integrated circuit component, may include one or more transistors (e.g., some of the transistors 740 of FIG. 7, discussed below), supporting circuitry to route electrical signals to the transistors, passive components (e.g., signal traces, resistors, capacitors, or inductors), and/or any other integrated circuit components. In some embodiments, the wafer 600 or the die 602 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Additionally, multiple devices may be combined on a single die 602. For example, a memory array formed by multiple memory devices may be formed on a same die 602 as a processor unit (e.g., the processor unit 902 of FIG. 9) or other logic that is configured to store information in the memory devices or execute instructions stored in the memory array. In some embodiments, a die 602 may be attached to a wafer 600 that includes other die, and the wafer 600 is subsequently singulated, this manufacturing procedure is referred to as a die-to-wafer assembly technique.

FIG. 7 is a cross-sectional side view of an integrated circuit 700 that may be included in any of the embodiments disclosed herein. One or more of the integrated circuits 700 may be included in one or more dies 602 (FIG. 6). The integrated circuit 700 may be formed on a die substrate 702 (e.g., the wafer 600 of FIG. 6) and may be included in a die (e.g., the die 602 of FIG. 6).

The die substrate 702 may be a semiconductor substrate composed of semiconductor material systems including, for example, n-type or p-type materials systems (or a combination of both). The die substrate 702 may include, for example, a crystalline substrate formed using a bulk silicon or a silicon-on-insulator (SOI) substructure. In some embodiments, the die substrate 702 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 702. Although a few examples of materials from which the die substrate 702 may be formed are described here, any material that may serve as a foundation for an integrated circuit 700 may be used. The die substrate 702 may be part of a singulated die (e.g., the dies 602 of FIG. 6) or a wafer (e.g., the wafer 600 of FIG. 6).

The integrated circuit 700 may include one or more device layers 704 disposed on the die substrate 702. The device layer 704 may include features of one or more transistors 740 (e.g., metal oxide semiconductor field-effect transistors (MOSFETs)) formed on the die substrate 702. The transistors 740 may include, for example, one or more source and/or drain (S/D) regions 720, a gate 722 to control current flow between the S/D regions 720, and one or more S/D contacts 724 to route electrical signals to/from the S/D regions 720.

The gate 722 may be formed of at least two layers, a gate dielectric and a gate electrode. The gate dielectric may include one layer or a stack of layers. The one or more layers may include silicon oxide, silicon dioxide, silicon carbide, and/or a high-k dielectric material. The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 740 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 740 along the source-channel-drain direction, the gate electrode may consist of a U-shaped structure that includes a bottom portion substantially parallel to the surface of the die substrate 702 and two sidewall portions that are substantially perpendicular to the top surface of the die substrate 702. In other embodiments, at least one of the metal layers that form the gate electrode may simply be a planar layer that is substantially parallel to the top surface of the die substrate 702 and does not include sidewall portions substantially perpendicular to the top surface of the die substrate 702. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 720 may be formed within the die substrate 702 adjacent to the gate 722 of individual transistors 740. The S/D regions 720 may be formed using an implantation/diffusion process or an etching/deposition process, for example. In the former process, dopants such as boron, aluminum, antimony, phosphorous, or arsenic may be ion-implanted into the die substrate 702 to form the S/D regions 720. An annealing process that activates the dopants and causes them to diffuse farther into the die substrate 702 may follow the ion-implantation process. In the latter process, the die substrate 702 may first be etched to form recesses at the locations of the S/D regions 720. An epitaxial deposition process may then be carried out to fill the recesses with material that is used to fabricate the S/D regions 720. In some implementations, the S/D regions 720 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 720 may be formed using one or more alternate semiconductor materials such as germanium or a group III-V material or alloy. In further embodiments, one or more layers of metal and/or metal alloys may be used to form the S/D regions 720.

Electrical signals, such as power and/or input/output (I/O) signals, may be routed to and/or from the devices (e.g., transistors 740) of the device layer 704 through one or more interconnect layers disposed on the device layer 704 (illustrated in FIG. 7 as interconnect layers 706-710). For example, electrically conductive features of the device layer 704 (e.g., the gate 722 and the S/D contacts 724) may be electrically coupled with the interconnect structures 728 of the interconnect layers 706-710. The one or more interconnect layers 706-710 may form a metallization stack (also referred to as an “ILD stack”) 719 of the integrated circuit 700.

The interconnect structures 728 may be arranged within the interconnect layers 706-710 to route electrical signals according to a wide variety of designs; in particular, the arrangement is not limited to the particular configuration of interconnect structures 728 depicted in FIG. 7. Although a particular number of interconnect layers 706-710 is depicted in FIG. 7, embodiments of the present disclosure include integrated circuits having more or fewer interconnect layers than depicted.

In some embodiments, the interconnect structures 728 may include lines 728a and/or vias 728b filled with an electrically conductive material such as a metal. The lines 728a may be arranged to route electrical signals in a direction of a plane that is substantially parallel with a surface of the die substrate 702 upon which the device layer 704 is formed. For example, the lines 728a may route electrical signals in a direction in and out of the page and/or in a direction across the page. The vias 728b may be arranged to route electrical signals in a direction of a plane that is substantially perpendicular to the surface of the die substrate 702 upon which the device layer 704 is formed. In some embodiments, the vias 728b may electrically couple lines 728a of different interconnect layers 706-710 together.

The interconnect layers 706-710 may include a dielectric material 726 disposed between the interconnect structures 728, as shown in FIG. 7. In some embodiments, dielectric material 726 disposed between the interconnect structures 728 in different ones of the interconnect layers 706-710 may have different compositions; in other embodiments, the composition of the dielectric material 726 between different interconnect layers 706-710 may be the same. The device layer 704 may include a dielectric material 726 disposed between the transistors 740 and a bottom layer of the metallization stack as well. The dielectric material 726 included in the device layer 704 may have a different composition than the dielectric material 726 included in the interconnect layers 706-710; in other embodiments, the composition of the dielectric material 726 in the device layer 704 may be the same as a dielectric material 726 included in any one of the interconnect layers 706-710.

A first interconnect layer 706 (referred to as Metal 1 or “M1”) may be formed directly on the device layer 704. In some embodiments, the first interconnect layer 706 may include lines 728a and/or vias 728b, as shown. The lines 728a of the first interconnect layer 706 may be coupled with contacts (e.g., the S/D contacts 724) of the device layer 704. The vias 728b of the first interconnect layer 706 may be coupled with the lines 728a of a second interconnect layer 708.

The second interconnect layer 708 (referred to as Metal 2 or “M2”) may be formed directly on the first interconnect layer 706. In some embodiments, the second interconnect layer 708 may include via 728b to couple the lines 728 of the second interconnect layer 708 with the lines 728a of a third interconnect layer 710. Although the lines 728a and the vias 728b are structurally delineated with a line within individual interconnect layers for the sake of clarity, the lines 728a and the vias 728b may be structurally and/or materially contiguous (e.g., simultaneously filled during a dual-damascene process) in some embodiments.

The third interconnect layer 710 (referred to as Metal 3 or “M3”) (and additional interconnect layers, as desired) may be formed in succession on the second interconnect layer 708 according to similar techniques and configurations described in connection with the second interconnect layer 708 or the first interconnect layer 706. In some embodiments, the interconnect layers that are “higher up” in the metallization stack 719 in the integrated circuit 700 (i.e., farther away from the device layer 704) may be thicker that the interconnect layers that are lower in the metallization stack 719, with lines 728a and vias 728b in the higher interconnect layers being thicker than those in the lower interconnect layers.

The integrated circuit 700 may include a solder resist material 734 (e.g., polyimide or similar material) and one or more conductive contacts 736 formed on the interconnect layers 706-710. In FIG. 7, the conductive contacts 736 are illustrated as taking the form of bond pads. The conductive contacts 736 may be electrically coupled with the interconnect structures 728 and configured to route the electrical signals of the transistor(s) 740 to external devices. For example, solder bonds may be formed on the one or more conductive contacts 736 to mechanically and/or electrically couple an integrated circuit die including the integrated circuit 700 with another component (e.g., a printed circuit board). The integrated circuit 700 may include additional or alternate structures to route the electrical signals from the interconnect layers 706-710; for example, the conductive contacts 736 may include other analogous features (e.g., posts) that route the electrical signals to external components.

In some embodiments in which the integrated circuit 700 is a double-sided die, the integrated circuit 700 may include another metallization stack (not shown) on the opposite side of the device layer(s) 704. This metallization stack may include multiple interconnect layers as discussed above with reference to the interconnect layers 706-710, to provide conductive pathways (e.g., including conductive lines and vias) between the device layer(s) 704 and additional conductive contacts (not shown) on the opposite side of the integrated circuit 700 from the conductive contacts 736.

In other embodiments in which the integrated circuit 700 is a double-sided die, the integrated circuit 700 may include one or more through silicon vias (TSVs) through the die substrate 702; these TSVs may make contact with the device layer(s) 704, and may provide conductive pathways between the device layer(s) 704 and additional conductive contacts (not shown) on the opposite side of the integrated circuit 700 from the conductive contacts 736. In some embodiments. TSVs extending through the substrate can be used for routing power and ground signals from conductive contacts on the opposite side of the integrated circuit 700 from the conductive contacts 736 to the transistors 740 and any other components integrated into the die 700, and the metallization stack 719 can be used to route I/O signals from the conductive contacts 736 to transistors 740 and any other components integrated into the die 700.

Multiple integrated circuits 700 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

FIG. 8 is a cross-sectional side view of a semiconductor multi-chip package 800 that may include any of the embodiments disclosed herein. The multi-chip package 800 includes multiple semiconductor components disposed on a package substrate or circuit board 802 (which may be a motherboard, system board, mainboard, etc.). The multi-chip package 800 represents another embodiment of the semiconductor assembly 200 of FIG. 2A, and circuit board 802 may correspond to a package substrate similar to package substrate 222 of FIG. 2A, by way of example.

The multi-chip package may, according to an example, include an IC-PIC-FAU assembly 224 similar to the one described above in detail in relation to FIG. 2A above.

The multi-chip package 800 may include components disposed on a first face 840 of the circuit board 802 and an opposing second face 842 of the circuit board 802; generally, components may be disposed on one or both faces 840 and 842.

In some embodiments, the circuit board 802 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 802. In other embodiments, the circuit board 802 may be a non-PCB substrate. The multi-chip package 800 illustrated in FIG. 8 includes a package-on-interposer structure 836 coupled to the first face 840 of the circuit board 802 by coupling components 816. The coupling components 816 may electrically and mechanically couple the package-on-interposer structure 836 to the circuit board 802, and may include solder balls (as shown in FIG. 8), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 836 may include an integrated circuit component 820 coupled to an interposer 804 by coupling components 818. The coupling components 818 may take any suitable form for the application, such as the forms discussed above with reference to the coupling components 816. Although a single integrated circuit component 820 is shown in FIG. 8, multiple integrated circuit components may be coupled to the interposer 804; indeed, additional interposers may be coupled to the interposer 804. The interposer 804 may provide an intervening substrate used to bridge the circuit board 802 and the integrated circuit component 820.

The integrated circuit component 820 may be a packaged or unpackaged integrated circuit component that includes one or more integrated circuit dies (e.g., the die 602 of FIG. 6, the integrated circuit 700 of FIG. 7) and/or one or more other suitable components.

The unpackaged integrated circuit component 820 comprises solder bumps attached to contacts on the die. The solder bumps allow the die to be directly attached to the interposer 804. In embodiments where the integrated circuit component 820 comprises multiple integrated circuit dies, the dies can be of the same type (a homogeneous multi-die integrated circuit component) or of two or more different types (a heterogeneous multi-die integrated circuit component). In addition to comprising one or more processor units, the integrated circuit component 820 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof. A packaged multi-die integrated circuit component can be referred to as a multi-chip package (MCP) or multi-chip module (MCM).

Generally, the interposer 804 may spread connections to a wider pitch or reroute a connection to a different connection. For example, the interposer 804 may couple the integrated circuit component 820 to a set of ball grid array (BGA) conductive contacts of the coupling components 816 for coupling to the circuit board 802. In the embodiment illustrated in FIG. 8, the integrated circuit component 820 and the circuit board 802 are attached to opposing sides of the interposer 804; in other embodiments, the integrated circuit component 820 and the circuit board 802 may be attached to a same side of the interposer 804. In some embodiments, three or more components may be interconnected by way of the interposer 804.

In some embodiments, the interposer 804 may be formed as a PCB, including multiple metal layers separated from one another by layers of dielectric material and interconnected by electrically conductive vias. In some embodiments, the interposer 804 may be formed of an epoxy resin, a fiberglass-reinforced epoxy resin, an epoxy resin with inorganic fillers, a ceramic material, or a polymer material such as polyimide. In some embodiments, the interposer 804 may be formed of alternate rigid or flexible materials that may include the same materials described above for use in a semiconductor substrate, such as silicon, germanium, and other group III-V and group IV materials. The interposer 804 may include metal interconnects 808 and vias 810-1 and 810-2, including but not limited to through hole vias 810-1 (that extend from a first face 850 of the interposer 804 to a second face 854 of the interposer 804), blind vias 810-2 (that extend from the first or second faces 850 or 854 of the interposer 804 to an internal metal layer), and buried vias 810-3 (that connect internal metal layers).

In some embodiments, the interposer 804 can comprise a silicon interposer. Through silicon vias (TSV) extending through the silicon interposer can connect connections on a first face of a silicon interposer to an opposing second face of the silicon interposer. In some embodiments, an interposer 804 comprising a silicon interposer can further comprise one or more routing layers to route connections on a first face of the interposer 804 to an opposing second face of the interposer 804.

The interposer 804 may further include embedded devices 814, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 804. The package-on-interposer structure 836 may take the form of any of the package-on-interposer structures known in the art. In embodiments where the interposer is a non-printed circuit board

The multi-chip package 800 illustrated in FIG. 8 includes a package-on-package structure 834 coupled to the second face 842 of the circuit board 802 by coupling components 828. The package-on-package structure 834 may include an integrated circuit component 826 and an integrated circuit component 832 coupled together by coupling components 830 such that the integrated circuit component 826 is disposed between the circuit board 802 and the integrated circuit component 832. The coupling components 828 and 830 may take the form of any of the embodiments of the coupling components 816 discussed above, and the integrated circuit components 826 and 832 may take the form of any of the embodiments of the integrated circuit component 820 discussed above. The package-on-package structure 834 may be configured in accordance with any of the package-on-package structures known in the art.

FIG. 9 is a block diagram of an example electrical device 900 that may include one or more of the embodiments disclosed herein. For example, any suitable electrical device 900 may include one or more of the multi-chip packages 800, integrated circuit components 820, integrated circuits 700, integrated circuit dies 602, or PICs 220, 320′ or 320″ disclosed herein. Although the electrical device 900 is depicted as including a number of components in FIG. 9, any one or more of these components may be omitted or duplicated, as suitable for the application. In some embodiments, some or all of the components included in the electrical device 900 may be attached to one or more motherboards mainboards, printed circuit boards, or system boards. In some embodiments, one or more of these components are fabricated onto a single system-on-a-chip (SoC) die.

Additionally, in various embodiments, the electrical device 900 may not include one or more of the components illustrated in FIG. 9, but the electrical device 900 may include interface circuitry for coupling to the one or more components. For example, the electrical device 900 may not include a display device 906, but may include display device interface circuitry (e.g., a connector and driver circuitry) to which a display device 906 may be coupled. In another set of examples, the electrical device 900 may not include an audio input device 924 or an audio output device 908, but may include audio input or output device interface circuitry (e.g., connectors and supporting circuitry) to which an audio input device 924 or audio output device 908 may be coupled.

The electrical device 900 may include, within a housing 901, one or more processor units 902 (e.g., one or more processor units). As used herein, the terms “processor unit,” “processing unit” or “processor” may refer to any device or portion of a device that processes electronic data from registers and/or memory to transform that electronic data into other electronic data that may be stored in registers and/or memory. The processor unit 902 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller crypto processors (specialized processors that execute cryptographic algorithms within hardware), server processors, controllers, or any other suitable type of processor units. As such, the processor unit can be referred to as an XPU (or xPU).

The electrical device 900 may include a memory 904, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 904 may include memory that is located on the same integrated circuit die as the processor unit 902. This memory may be used as cache memory (e.g., Level 1 (L1), Level 2 (L2), Level 3 (L3), Level 4 (L4), Last Level Cache (LLC)) and may include embedded dynamic random-access memory (eDRAM) or spin transfer torque magnetic random-access memory (STT-MRAM).

In some embodiments, the electrical device 900 can comprise one or more processor units 902 that are heterogeneous or asymmetric to another processor unit 902 in the electrical device 900. There can be a variety of differences between the processing units 902 in a system in terms of a spectrum of metrics of merit including architectural, microarchitectural, thermal, power consumption characteristics, and the like. These differences can effectively manifest themselves as asymmetry and heterogeneity among the processor units 902 in the electrical device 900.

In some embodiments, the electrical device 900 may include a communication component 912 (e.g., one or more communication components). For example, the communication component 912 can manage wireless communications for the transfer of data to and from the electrical device 900. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 912 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 912 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 912 may operate in accordance with other wireless protocols in other embodiments. The electrical device 900 may include an antenna 922 to facilitate wireless communications and/or to receive other wireless communications (such as AM or FM radio transmissions).

In some embodiments, the communication component 912 may manage wired communications, such as electrical, optical, or any other suitable communication protocols (e.g., IEEE 802.3 Ethernet standards). As noted above, the communication component 912 may include multiple communication components. For instance, a first communication component 912 may be dedicated to shorter-range wireless communications such as Wi-Fi or Bluetooth, and a second communication component 912 may be dedicated to longer-range wireless communications such as global positioning system (GPS), EDGE, GPRS, CDMA, WiMAX, LTE, EV-DO, or others. In some embodiments, a first communication component 912 may be dedicated to wireless communications, and a second communication component 912 may be dedicated to wired communications.

The electrical device 900 may include battery/power circuitry 914. The battery/power circuitry 914 may include one or more energy storage devices (e.g., batteries or capacitors) and/or circuitry for coupling components of the electrical device 900 to an energy source separate from the electrical device 900 (e.g., AC line power).

The electrical device 900 may include a display device 906 (or corresponding interface circuitry, as discussed above). The display device 906 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 900 may include an audio output device 908 (or corresponding interface circuitry, as discussed above). The audio output device 908 may include any embedded or wired or wirelessly connected external device that generates an audible indicator, such speakers, headsets, or earbuds.

The electrical device 900 may include an audio input device 924 (or corresponding interface circuitry, as discussed above). The audio input device 924 may include any embedded or wired or wirelessly connected device that generates a signal representative of a sound, such as microphones, microphone arrays, or digital instruments (e.g., instruments having a musical instrument digital interface (MIDI) output). The electrical device 900 may include a Global Navigation Satellite System (GNSS) device 918 (or corresponding interface circuitry, as discussed above), such as a Global Positioning System (GPS) device. The GNSS device 918 may be in communication with a satellite-based system and may determine a geolocation of the electrical device 900 based on information received from one or more GNSS satellites, as known in the art.

The electrical device 900 may include another output device 910 (or corresponding interface circuitry, as discussed above). Examples of the other output device 910 may include an audio codec, a video codec, a printer, a wired or wireless transmitter for providing information to other devices, or an additional storage device.

The electrical device 900 may include another input device 920 (or corresponding interface circuitry, as discussed above). Examples of the other input device 920 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 900 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra-mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 900 may be any other electronic device that processes data. In some embodiments, the electrical device 900 may comprise multiple discrete physical components. Given the range of devices that the electrical device 900 can be manifested as in various embodiments, in some embodiments, the electrical device 900 can be referred to as a computing device or a computing system.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of embodiments has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

In embodiments, the phrase “A is located on B” means that at least a part of A is in direct physical contact or indirect physical contact (having one or more other features between A and B) with at least a part of B.

In the instant description, “A is adjacent to B” means that at least part of A is in direct physical contact with at least a part of B.

In the instant description, “B is between A and C” means that at least part of B is in or along a space separating A and C and that the at least part of B is in direct or indirect physical contact with A and C.

In the instant description, “A is attached to B” means that at least part of A is mechanically attached to at least part of B, either directly or indirectly (having one or more other features between A and B).

In the instant description, “the As are coupled to the Bs” means that at least some of the As are coupled to at least some of the Bs, and not necessarily that all As are coupled to at least one B and all Bs are coupled to at least one A.

In the instant description, “A is within B” means that at least some of A is encompassed within the physical boundaries of B.

The use of reference numerals separated by a “/”, such as “102/104” for example, is intended to refer to 102 or 104 as appropriate. Otherwise, the forward slash (“/”) as used herein means “and/or.”

When used to describe a range of dimensions, the phrase “between X and Y” represents a range that includes X and Y. For convenience, the phrase “FIG. 2” may be used to refer to the collection of drawings of FIGS. 2A-2C, the phrase “FIG. 5” may be used to refer to the collection of drawings of FIGS. 5A-5I, etc. Although certain elements may be referred to in the singular herein, such elements may include multiple sub-elements. For example, “an insulating material” may include one or more insulating materials. As used herein, a “conductive contact” may refer to a portion of conductive material (e.g., metal) serving as an electrical interface between different components; conductive contacts may be recessed in, flush with, or extending away from a surface of a component, and may take any suitable form (e.g., a conductive pad or socket, or portion of a conductive line or via).

The use of the techniques and structures provided herein can be detected using tools such as: electron microscopy including scanning/transmission electron microscopy (SEM/TEM), scanning transmission electron microscopy (STEM), nano-beam electron diffraction (NBD or NBED), and reflection electron microscopy (REM); composition mapping; x-ray crystallography or diffraction (XRD); energy-dispersive x-ray spectroscopy (EDX); secondary ion mass spectrometry (SIMS); time-of-flight SIMS (ToF-SIMS); atom probe imaging or tomography; local electrode atom probe (LEAP) techniques; 3D tomography; or high resolution physical or chemical analysis, to name a few suitable example analytical tools. In particular, such tools can indicate an integrated circuit including at least one semiconductor package including an embedded magnetic inductor.

In some embodiments, the techniques, processes and/or methods described herein can be detected based on the structures formed therefrom. In addition, in some embodiments, the techniques and structures described herein can be detected based on the benefits derived therefrom. Numerous configurations and variations will be apparent in light of this disclosure.

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” “according to some embodiments,” “in accordance with embodiments,” or “in embodiments,” which may each refer to one or more of the same or different embodiments. Furthermore, the terms “comprising,” “including,” “having,” and the like, as used with respect to embodiments of the present disclosure, are synonymous.

“Coupled” as used herein means that two or more elements are in direct physical contact, or that that two or more elements indirectly physically contact each other, but yet still cooperate or interact with each other (i.e. one or more other elements are coupled or connected between the elements that are said to be coupled with each other). The term “directly coupled” means that two or more elements are in direct contact.

As used herein, the term “module” refers to being part of, or including an ASIC, an electronic circuit, a system on a chip, a processor (shared, dedicated, or group), a solid state device, a memory (shared, dedicated, or group) that execute one or more software or firmware programs, a combinational logic circuit, and/or other suitable components that provide the described functionality.

As used herein, “electrically conductive” in some examples may refer to a property of a material having an electrical conductivity greater than or equal to 10⁷ Siemens per meter (S/m) at 20 degrees Celsius. Examples of such materials include Cu, Ag, Al, Au, W, Zn and Ni.

In the corresponding drawings of the embodiments, signals, currents, electrical biases, or magnetic or electrical polarities may be represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, polarity, current, voltage, etc., as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the elements that are connected, without any intermediary devices. The term “coupled” means a direct or indirect connection, such as a direct electrical, mechanical, or magnetic connection between the elements that are connected or an indirect connection, through one or more passive or active intermediary devices. The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about,” generally refer to being within +/−10% of a target value (unless specifically specified). Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner, and are not intended to imply that the objects so described must necessarily be made of different materials or have different dimensions.

For purposes of the embodiments, any transistors in various circuits and logic blocks described here are metal oxide semiconductor (MOS) transistors or their derivatives, where the MOS transistors include drain, source, gate, and bulk terminals. The transistors and/or the MOS transistor derivatives also include Tri-Gate and FinFET transistors, Gate All Around Cylindrical Transistors, Tunneling FET (TFET), Square Wire, or Rectangular Ribbon Transistors, ferroelectric FET (FeFETs), or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors—BJT PNP/NPN, BiCMOS, CMOS, eFET, etc., may be used without departing from the scope of the disclosure. The term “MN” indicates an n-type transistor (e.g., nMOS, NPN BJT, etc.) and the term “MP” indicates a p-type transistor (e.g., pMOS, PNP BJT, etc.).

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

### Examples

Some non-limiting example embodiments are set forth below.

Example 1 includes a semiconductor structure, comprising: a substrate; and an semiconductor layer on a top surface of the substrate and including a semiconductor material and an optical component, wherein: the substrate defines an air cavity therein extending in a direction from a bottom surface of the substrate toward and in registration with the optical component; and the semiconductor layer is free of any opening therethrough in communication with the air cavity.

Example 2 includes the subject matter of Example 1, wherein the optical component includes a heating element.

Example 3 includes the subject matter of Example 1, wherein the air cavity corresponds to a trench extending substantially perpendicularly with respect to the bottom surface of the substrate.

Example 4 includes the subject matter of Example 3, wherein the trench has sidewalls having a scalloped profile.

Example 5 includes the subject matter of Example 4, wherein the sidewalls define an angle smaller than 90 degrees with respect to the bottom surface of the substrate.

Example 6 includes the subject matter of any one of Examples 1-5, wherein the trench has a concave end surface nearest the optical component.

Example 7 includes the subject matter of any one of Examples 1-6, wherein the air cavity extends to a bottom surface of the semiconductor layer.

Example 8 includes the subject matter of any one of Examples 1-7, wherein the air cavity extends to a bottom surface of the substrate.

Example 9 includes the subject matter of any one of Examples 1-8, wherein the semiconductor layer includes a plurality of optical components in the semiconductor material, and wherein the air cavity extends in a direction from a bottom surface of the substrate toward and in registration with the plurality of optical components.

Example 10 includes the subject matter of any one of Examples 1-8, wherein: the semiconductor layer includes a plurality of optical components in the semiconductor material; and the substrate defines a plurality of cavities extending in a direction from a bottom surface of the substrate toward and in registration with respective ones of the plurality of optical components.

Example 11 includes the subject matter of Example 10, wherein the plurality of cavities define an array of cavity openings at a bottom surface of the substrate.

Example 12 includes the subject matter of any one of Examples 1-11, wherein the substrate includes silicon.

Example 13 includes the subject matter of any one of Examples 1-12, wherein the substrate includes a crystalline material.

Example 14 includes the subject matter of any one of Examples 1-13, wherein the semiconductor layer includes a first layer adjacent the substrate and including oxygen, a second layer including the semiconductor material and the optical component, and a third layer on the second layer and including oxygen, the second layer between the first layer and the third layer.

Example 15 includes the subject matter of Example 14, wherein the air cavity extends to a bottom surface of the first layer.

Example 16 includes the subject matter of any one of Examples 1-15, wherein the optical component includes a micro-ring resonator (MRR) or a Mach-Zehnder interferometer (MZI).

Example 17 includes a semiconductor assembly including: a package substrate; a photonic integrated circuit (PIC) on the package substrate, the PIC including: a PIC substrate; and a semiconductor layer on a top surface of the PIC substrate and including a semiconductor material and an optical component, wherein: the PIC substrate defines an air cavity therein extending in a direction from a bottom surface of the PIC substrate toward and in registration with the optical component; and the semiconductor layer is free of any opening therethrough in communication with the air cavity; and an electronic integrated circuit (EIC) on the package substrate, the EIC having electrically conductive structures at a bottom surface, the electrically conductive structures electrically coupled to at least one of the PIC and the package substrate.

Example 18 includes the subject matter of Example 17, wherein the optical component includes a heating element.

Example 19 includes the subject matter of Example 17, wherein the air cavity corresponds to a trench extending substantially perpendicularly with respect to the bottom surface of the PIC substrate.

Example 20 includes the subject matter of Example 19, wherein the trench has sidewalls having a scalloped profile.

Example 21 includes the subject matter of Example 20, wherein the sidewalls define an angle smaller than 90 degrees with respect to the bottom surface of the PIC substrate.

Example 22 includes the subject matter of any one of Examples 17-21, wherein the trench has a concave end surface nearest the optical component.

Example 23 includes the subject matter of any one of Examples 17-22, wherein the air cavity extends to a bottom surface of the semiconductor layer.

Example 24 includes the subject matter of any one of Examples 17-23, wherein the air cavity extends to a bottom surface of the PIC substrate.

Example 25 includes the subject matter of any one of Examples 17-24, wherein the semiconductor layer includes a plurality of optical components in the semiconductor material, and wherein the air cavity extends in a direction from a bottom surface of the PIC substrate toward and in registration with the plurality of optical components.

Example 26 includes the subject matter of any one of Examples 17-24, wherein: the semiconductor layer includes a plurality of optical components in the semiconductor material; and the PIC substrate defines a plurality of cavities extending in a direction from a bottom surface of the PIC substrate toward and in registration with respective ones of the plurality of optical components.

Example 27 includes the subject matter of Example 26, wherein the plurality of cavities define an array of cavity openings at a bottom surface of the PIC substrate.

Example 28 includes the subject matter of any one of Examples 17-27, wherein the PIC substrate includes silicon.

Example 29 includes the subject matter of any one of Examples 17-28, wherein the PIC substrate includes a crystalline material.

Example 30 includes the subject matter of any one of Examples 17-29, wherein the semiconductor layer includes a first layer adjacent the PIC substrate and including oxygen, a second layer including the semiconductor material and the optical component, and a third layer on the second layer and including oxygen, the second layer between the first layer and the third layer.

Example 31 includes the subject matter of Example 30, wherein the air cavity extends to a bottom surface of the first layer.

Example 32 includes the subject matter of any one of Examples 17-31, wherein the optical component includes a micro-ring resonator (MRR) or a Mach-Zehnder interferometer (MZI).

Example 33 includes a multi-chip package including: a package substrate; a photonic integrated circuit (PIC) on the package substrate, the PIC including: a PIC substrate; and a first semiconductor layer on a top surface of the PIC substrate and including a semiconductor material and an optical component, wherein: the PIC substrate defines an air cavity therein extending in a direction from a bottom surface of the PIC substrate toward and in registration with the optical component; and the first semiconductor layer is free of any opening therethrough in communication with the air cavity; a fiber array unit (FAU) coupled to the PIC; a first electronic integrated circuit (EIC) component on the package substrate, the first EIC having electrically conductive structures at a bottom surface, the electrically conductive structures electrically coupled to the PIC and electrically coupled to the package substrate ; and a semiconductor structure electrically coupled to the package substrate and including a second semiconductor layer having electrically conductive structures therein, and a second EIC electrically coupled to the second semiconductor layer.

Example 34 includes the subject matter of Example 33, wherein the optical component includes a heating element.

Example 35 includes the subject matter of Example 33, wherein the air cavity corresponds to a trench extending substantially perpendicularly with respect to the bottom surface of the PIC substrate.

Example 36 includes the subject matter of Example 35, wherein the trench has sidewalls having a scalloped profile.

Example 37 includes the subject matter of Example 20, wherein the sidewalls define an angle smaller than 90 degrees with respect to the bottom surface of the PIC substrate.

Example 38 includes the subject matter of any one of Examples 33-37, wherein the trench has a concave end surface nearest the optical component.

Example 39 includes the subject matter of any one of Examples 33-38. wherein the air cavity extends to a bottom surface of the semiconductor layer.

Example 40 includes the subject matter of any one of Examples 33-39. wherein the air cavity extends to a bottom surface of the PIC substrate.

Example 41 includes the subject matter of any one of Examples 33-40, wherein the semiconductor layer includes a plurality of optical components in the semiconductor material, and wherein the air cavity extends in a direction from a bottom surface of the PIC substrate toward and in registration with the plurality of optical components.

Example 42 includes the subject matter of any one of Examples 33-40, wherein: the semiconductor layer includes a plurality of optical components in the semiconductor material; and the PIC substrate defines a plurality of cavities extending in a direction from a bottom surface of the PIC substrate toward and in registration with respective ones of the plurality of optical components.

Example 43 includes the subject matter of Example 42, wherein the plurality of cavities define an array of cavity openings at a bottom surface of the PIC substrate.

Example 44 includes the subject matter of any one of Examples 33-43, wherein the PIC substrate includes silicon.

Example 45 includes the subject matter of any one of Examples 33-44, wherein the PIC substrate includes a crystalline material.

Example 46 includes the subject matter of any one of Examples 33-45, wherein the semiconductor layer includes a first layer adjacent the PIC substrate and including oxygen, a second layer including the semiconductor material and the optical component, and a third layer on the second layer and including oxygen, the second layer between the first layer and the third layer.

Example 47 includes the subject matter of Example 46, wherein the air cavity extends to a bottom surface of the first layer.

Example 48 includes the subject matter of any one of Examples 33-47, wherein the optical component includes a micro-ring resonator (MRR) or a Mach-Zehnder interferometer (MZI).

Example 49 method of making a photonic integrated circuit (PIC) including: providing a PIC substrate; and providing a semiconductor layer on a top surface of the PIC substrate and including a semiconductor material and an optical component; and forming a cavity from a bottom surface of the PIC substrate and extending in a direction toward and in registration with the optical component without providing any opening through the semiconductor layer in communication with the air cavity.

Example 50 includes the subject matter of any one of Examples 49-50, including: providing a wafer including a PIC substrate stratum and a semiconductor layer stratum on the PIC substrate stratum, the semiconductor layer stratum including a plurality of optical components one of which is the optical component; from an exposed bottom surface of the PIC substrate stratum, forming a plurality of cavities one of which is the air cavity, individual ones of the cavities extending in a direction toward and in registration with one or more corresponding ones the optical components; and singulating a plurality of PICs from the wafer, the plurality of PICs including the PIC.

Example 51 includes the subject matter of Example 50, wherein at least one of forming the air cavity and singulating includes plasma etching.

Example 52 includes the subject matter of any one of Examples 50 and 51, wherein forming the plurality of cavities and singulating at least partially overlap in time.

Example 53 includes the subject matter of any one of Examples 49-52, wherein the optical component includes a heating element.

Example 54 includes the subject matter of any one of Examples 49-52. wherein the air cavity corresponds to a trench extending substantially perpendicularly with respect to the bottom surface of the PIC substrate.

Example 55 includes the subject matter of any one of Examples 49-54, wherein the trench has sidewalls having a scalloped profile.

Example 56 includes the subject matter of Example 55, wherein the sidewalls define an angle smaller than 90 degrees with respect to the bottom surface of the PIC substrate.

Example 57 includes the subject matter of any one of Examples 51-56, wherein the trench has a concave end surface nearest the optical component.

Example 58 includes the subject matter of any one of Examples 49-57, wherein the air cavity extends to a bottom surface of the semiconductor layer.

Example 59 includes the subject matter of any one of Examples 49-58, wherein the air cavity extends to a bottom surface of the PIC substrate.

Example 60 includes the subject matter of Example 49, wherein the semiconductor layer includes a plurality of optical components in the semiconductor material, and wherein the air cavity extends in a direction from a bottom surface of the PIC substrate toward and in registration with the plurality of optical components.

Example 61 includes the subject matter of Example 49, wherein: the semiconductor layer includes a plurality of optical components in the semiconductor material; and the PIC substrate defines a plurality of cavities extending in a direction from a bottom surface of the PIC substrate toward and in registration with respective ones of the plurality of optical components.

Example 62 includes the subject matter of Example 61, wherein the plurality of cavities define an array of cavity openings at a bottom surface of the PIC substrate.

Example 63 includes the subject matter of any one of Examples 49-62, wherein the PIC substrate includes silicon.

Example 64 includes the subject matter of any one of Examples 49-63, wherein the PIC substrate includes a crystalline material.

Example 65 includes the subject matter of any one of Examples 49-64, wherein the semiconductor layer includes a first layer adjacent the PIC substrate and including oxygen, a second layer including the semiconductor material and the optical component, and a third layer on the second layer and including oxygen, the second layer between the first layer and the third layer.

Example 66 includes the subject matter of Example 65, wherein the air cavity extends to a bottom surface of the first layer.

Example 67 includes the subject matter of any one of Examples 49-66, wherein the optical component includes a micro-ring resonator (MRR) or a Mach-Zehnder interferometer (MZI).

What is claimed is:

1. A semiconductor structure, comprising:
a substrate; and
an semiconductor layer on a top surface of the substrate and including a semiconductor material and an optical component, wherein:
the substrate defines an air cavity therein extending in a direction from a bottom surface of the substrate toward and in registration with the optical component; and
the semiconductor layer is free of any opening therethrough in communication with the air cavity.

2. The semiconductor structure of claim 1, wherein the optical component includes a heating element.

3. The semiconductor structure of claim 1, wherein the air cavity corresponds to a trench extending substantially perpendicularly with respect to the bottom surface of the substrate.

4. The semiconductor structure of claim 3, wherein the trench has sidewalls having a scalloped profile.

5. The semiconductor structure of claim 4, wherein the sidewalls define an angle smaller than 90 degrees with respect to the bottom surface of the substrate.

6. The semiconductor structure of claim 3, wherein the trench has a concave end surface nearest the optical component.

7. The semiconductor structure of claim 1, wherein the air cavity extends to a bottom surface of the semiconductor layer.

8. The semiconductor structure of claim 1, wherein the air cavity extends to a bottom surface of the substrate.

9. The semiconductor structure of claim 1, wherein the semiconductor layer includes a plurality of optical components in the semiconductor material, and wherein the air cavity extends in a direction from a bottom surface of the substrate toward and in registration with the plurality of optical components.

10. The semiconductor structure of claim 1, wherein:
the semiconductor layer includes a plurality of optical components in the semiconductor material; and
the substrate defines a plurality of cavities extending in a direction from a bottom surface of the substrate toward and in registration with respective ones of the plurality of optical components.

11. The semiconductor structure of claim 10, wherein the plurality of cavities define an array of cavity openings at a bottom surface of the substrate.

12. A semiconductor assembly including:
a package substrate;
a photonic integrated circuit (PIC) on the package substrate, the PIC including:
a PIC substrate; and
a semiconductor layer on a top surface of the PIC substrate and including a semiconductor material and an optical component, wherein:
the PIC substrate defines an air cavity therein extending in a direction from a bottom surface of the PIC substrate toward and in registration with the optical component; and
the semiconductor layer is free of any opening therethrough in communication with the air cavity; and
an electronic integrated circuit (EIC) component on the package substrate, the EIC having electrically conductive structures at a bottom surface thereof , the electrically conductive structures electrically coupled to at least one of the PIC and the package substrate.

13. The semiconductor assembly of claim 12, wherein the PIC substrate includes silicon.

14. The semiconductor assembly of claim 12, wherein the air cavity extends to a bottom surface of the semiconductor layer.

15. A multi-chip package including:
a package substrate;
a photonic integrated circuit (PIC) on the package substrate, the PIC including:
a PIC substrate; and
a first semiconductor layer on a top surface of the PIC substrate and including a semiconductor material and an optical component, wherein:
the PIC substrate defines an air cavity therein extending in a direction from a bottom surface of the PIC substrate toward and in registration with the optical component; and
the first semiconductor layer is free of any opening therethrough in communication with the air cavity;
a fiber array unit (FAU) coupled to the PIC;
a first electronic integrated circuit (EIC) component on the package substrate, the first EIC having electrically conductive structures at a bottom surface thereof, the electrically conductive structures electrically coupled to the PIC and electrically coupled to the package substrate; and
a semiconductor structure electrically coupled to the package substrate and including a second semiconductor layer having electrically conductive structures therein, and a second EIC electrically coupled to the second semiconductor layer.

16. The multi-chip package of claim 15, wherein the PIC substrate includes a crystalline material.

17. The multi-chip package of claim 15, wherein the optical component includes a micro-ring resonator (MRR) or a Mach-Zehnder interferometer (MZI).

18. A method of making a photonic integrated circuit (PIC) including:
providing a PIC substrate; and
providing a semiconductor layer on a top surface of the PIC substrate and including a semiconductor material and an optical component; and
forming an air cavity from a bottom surface of the PIC substrate and extending in a direction toward and in registration with the optical component without providing any opening through the semiconductor layer in communication with the air cavity.

19. The method of claim 18, including:
providing a wafer including a PIC substrate stratum and a semiconductor layer stratum on the PIC substrate stratum, the semiconductor layer stratum including a plurality of optical components one of which is the optical component;
from an exposed bottom surface of the PIC substrate stratum, forming a plurality of cavities one of which is the air cavity, individual ones of the cavities extending in a direction toward and in registration with one or more corresponding ones the optical components; and
singulating a plurality of PICs from the wafer, the plurality of PICs including the PIC.

20. The method of claim 19, wherein at least one of forming the air cavity and singulating includes plasma etching.
